(19) United States
(12) Patent Application Publication
(10) Pub. No.: US 2016/0127778 A1
(43) Pub. Date: May 5, 2016

(54) HEAD END DETECTION

(71) Applicant: Microsoft Technology Licensing, LLC, Redmond, WA (US)

(72) Inventors: Shailendra Mishra, Kenmore, WA (US); Andrew Jaffray, Seattle, WA (US); August W. Hill, Redmond, WA (US)

(21) Appl. No.: 14/528,059

(22) Filed: Oct. 30, 2014

(51) Int. Cl. H04N 21/462; H04N 21/44; H04N 21/466; H04N 21/222; H04N 21/234; H04N 21/81; H04N 21/454; H04N 21/2668

(52) U.S. Cl. CPC H04N 21/4622; H04N 21/454; H04N 21/44008; H04N 21/2668; H04N 21/2221; H04N 21/23418; H04N 21/8173; H04N 21/4668

(57) ABSTRACT

One or more techniques and/or systems are provided for head end detection. A media receiver, such as a cable box, may be configured to receive cable television programming from a head end providing a channel lineup subscribed to by a user of the media receiver. Because an intermediate multimedia device, such as a computer or videogame system, may provide robust functionality for the cable television programming, it may be advantageous to identify and make the intermediate multimedia device aware of the head end. Accordingly, imagery of media channels may be captured from the media receiver. The imagery may be compared with fingerprints of content shows to identify a set of content provided by the head end. The set of content may be evaluated against channel head end lineup information to determine the head end (e.g., head ends that do not include content shows within the set of content are disqualified).

### BACKGROUND

Many content providers, such as cable television providers, provide various channel lineups of cable television programming through head ends that are available for a location of a user. The user may subscribe to a channel lineup that is provided by a head end of a content provider. The user may utilize a media receiver, such as a cable box, to receive a media channel signal from the head end. The media receiver may display cable television programming on a display, such as a television display, based upon the media channel signal.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for head end detection are provided herein. In an example, contextual information of a media receiver may be identified. A channel evaluation threshold may be determined based upon the contextual information and head end distinguishing channel information. The channel evaluation threshold may be indicative of at least one of a number of media channels to evaluate or an evaluation order with which to evaluate media channels. Imagery may be captured from the media receiver based upon the channel evaluation threshold. A visual content recognition service may be invoked to evaluate the imagery against a set of content fingerprints to identify a set of content corresponding to the imagery. The set of content may be evaluated against head end channel lineup information to determine a head end associated with the media receiver.

In another example, contextual information of a media receiver may be identified. A set of potential head ends may be determined based upon the contextual information. First imagery may be captured from the media receiver. The first imagery may correspond to a first media channel. A visual content recognition service may be invoked to evaluate the first imagery against a set of content fingerprints to identify a first content show of the first media channel. The set of potential head ends may be filtered based upon the first content show to create a filtered set of potential head ends. The filtered set of potential head ends may be iteratively filtered, based upon content shows identified by invocation of the visual content recognition service using imagery captured from the media receiver, until the filtered set of potential head ends is indicative of a head end associated with the media receiver.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of head end detection.

FIG. 2 is an illustration of an example of providing cable television programming to a display.

FIG. 3A is a component block diagram illustrating an exemplary system for head end detection, where a set of potential head ends are identified and a channel evaluation threshold is determined.

FIG. 3B is an illustration of an example of a set of potential head ends and/or head end distinguishing channel information.

FIG. 3C is a component block diagram illustrating an exemplary system for head end detection, where a head end detection component captures imagery from a media receiver.

FIG. 3D is a component block diagram illustrating an exemplary system, subsequent to FIG. 3C, for head end detection, where a head end detection component captures imagery from a media receiver.

FIG. 3E is a component block diagram illustrating an exemplary system, subsequent to FIG. 3D, for head end detection, where a head end detection component captures imagery from a media receiver.

FIG. 3F is a component block diagram illustrating an exemplary system for head end detection, where a visual content recognition service is invoked to identify a set of content corresponding to imagery.

FIG. 3M is a component block diagram illustrating an exemplary system for head end detection, where an intermediate multimedia device component provides functionality for a head end associated with a media receiver.

FIG. 4 is a flow diagram illustrating an exemplary method of head end detection.

FIG. 5 is a flow diagram illustrating an exemplary method of head end detection.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for head end detection are provided herein. An intermediate multimedia device, such as a videogame console connected between a media receiver (e.g., a cable box) and a television display may identify a head end that provides a channel lineup subscribed to by a user of the media receiver. The head end may be identified based upon visual content recognition of imagery captured from the media receiver. The head end may be identified automatically (e.g., programmatically) such that little to no information is solicited from the user, thus enhancing the user experience, expediting the process, providing more accurate results (e.g., where the user is unsure how to answer information solicitation questions), etc.

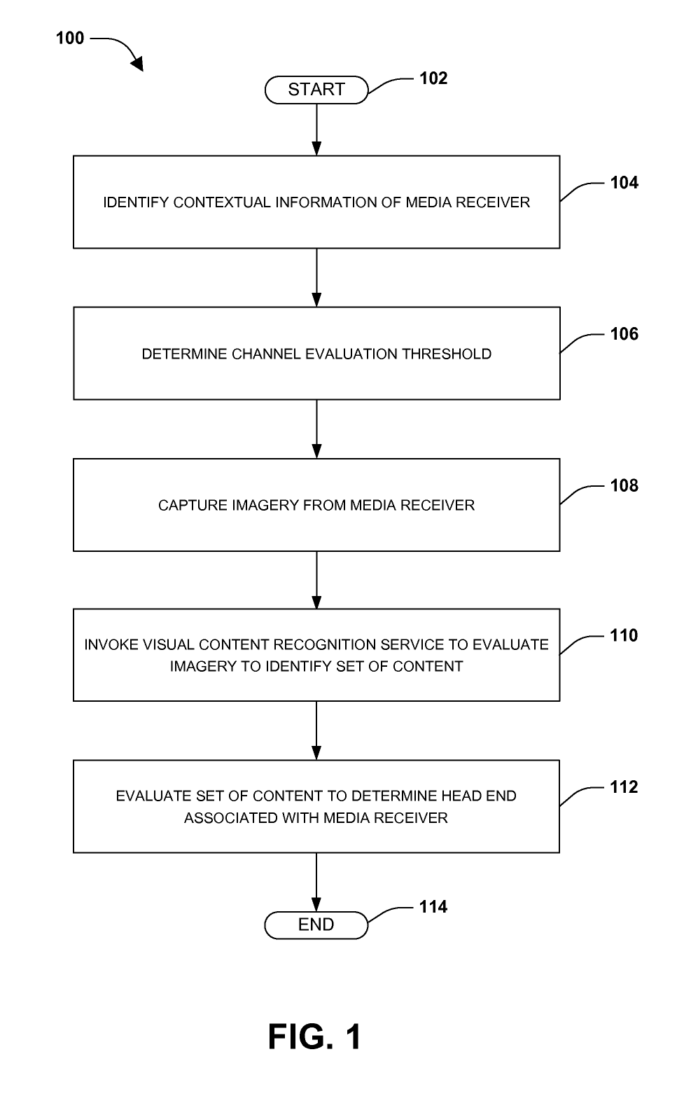

An embodiment of head end detection is illustrated by an exemplary method 100 of FIG. 1. At 102, the method starts. A media receiver, such as a cable box, may be configured to receive a media channel signal from a head end. The media channel signal may comprise cable television programming such as a media channels of a channel lineup provided by the head end (e.g., a user of the media receiver may subscribe to a digital package with an additional premium sports package provided by a first content provider). The media receiver may display media channels of the channel lineup (e.g., cable television programming, such as sitcom content shows, news content shows, sports content shows, etc.) on a television display based upon the media channel signal. A head end detection component and/or an intermediate multimedia device component, hosted on the television display or on an intermediate multimedia device such as a videogame console, may be configured to detect the head end and/or provide a robust experience for the cable television programming provided by the head end. For example, the intermediate multimedia device may be communicatively coupled to the media receiver by a first connection, and may be communicatively coupled to a display, such as the television display, by a second connection.

At 104, contextual information (e.g., a location, a cable provider name, etc.) of the media receiver may be identified. For example, an IP address (e.g., an IP address of the videogame console), a wifi signal, a cellphone tower location (e.g., detected from a SIM card of the intermediate multimedia device such as a mobile device), a Bluetooth signal, or any other information may be evaluated to identify a zip code, for example, as the contextual information (e.g., location) of the media receiver.

At 106, a channel evaluation threshold may be determined based upon the contextual information and/or head end distinguishing channel information. The channel evaluation threshold may be indicative of a number of media channels to evaluate and/or an evaluation order with which to evaluate media channels. For example, a set of potential head ends may be identified based upon the location (e.g., 10 potential head ends may be available for the location of the media receiver). The head end distinguishing channel information may be derived from channel lineups of the potential head ends (e.g., channel 2 may correspond to a sports programming network on a first potential head end, but may correspond to a kids programming network on a second potential head end, and thus an evaluation of channel 2 may be performed to distinguish between whether the media receiver is subscribed to the first potential head end or the second potential head end). In this way, the channel evaluation threshold may specify a minimum set of media channels to evaluate (e.g., content, such as television shows, on channel 2, channel 5, and channel 9 may match a single potential head end within the set of potential head ends (e.g., merely the first potential head end may have a football game on channel 2, a sitcom on channel 5, and a shopping network purse show on channel 9 at 2:30 pm)). As content of media channels are identified, potential head ends may be iteratively removed from the set of potential head ends to determine the head end associated with the media receiver (e.g., a single remaining potential head end, within the set of potential head ends, may be identified as being associated with the media receiver because a channel lineup of the remaining potential head end may match televisions shows identified from imagery captured from the media receiver). In this way, the number of channels that need to be evaluated to identify a head end of the media receiver may be reduced (e.g., minimized) as indicated by the channel evaluation threshold (e.g., an optimally small set of channels to evaluate). In another example, the number of channels that need to be evaluated to identify the head end of the media receiver may be reduced (e.g., minimized) by determining an evaluation order with which to evaluate channels so that evaluating channels according to the evaluation order will lead to an identification of the head end sooner than a different ordering, such as where the differing ordering is merely an ascending or descending order.

At 108, imagery may be captured from the media receiver based upon the channel evaluation threshold. For example, the media receiver may be tuned to channel 2, and a first snapshot of programming content of channel 2 may be captured for inclusion within the imagery. The media receiver may be tuned to channel 5, and a second snapshot of programming content of channel 5 may be captured for inclusion within the imagery. The media receiver may be tuned to channel 9, and a third snapshot of programming content of channel 9 may be captured for inclusion within the imagery. In an example, the imagery may be captured in real-time during broadcast of the programming content to the media receiver.

At 110, a visual content recognition service (e.g., an automatic content recognition (ACR) service; a user prompt comprising questions, options, etc. that may be provided to a user soliciting feedback regarding what content is playing on what channels; etc.) may be invoked to evaluate the imagery and/or timestamps of such imagery against a set of content fingerprints (e.g., descriptive information and/or visual features, such as recognition of an actor or a network symbol/icon, that may be used to label imagery as corresponding to particular content, such as a particular television show) to identify a set of content corresponding to the imagery. For example, the first snapshot of channel 2 may match a football game content fingerprint for 2:30 pm, the second snapshot of channel 5 may match a sitcom content fingerprint for 2:30 pm, and the third snapshot of channel 9 may match a shopping network purse show content fingerprint for 2:30 pm. In this way, the set of content may comprise a football content identifier for channel 2, a sitcom content identifier for channel 5, and a shopping network purse show content identifier for channel 9.

At 112, the set of content may be evaluated against head end channel lineup information (e.g., channel lineups of the 10 potential head ends within the set of potential head ends) to determine a head end associated with the media receiver. For example, potential head ends that do not match the set of content (e.g., based upon the head end distinguishing channel information) may be iteratively removed from the set of potential head ends until the set of potential head ends comprises a single head end that may be identified as the head end associated with the media receiver (e.g., potential head ends with channel lineups that do not match football at 2:30 pm for channel 2 may be removed from the set of potential head ends; potential head ends with channel lineups that do not match the sitcom at 2:30 pm for channel 5 may be removed from the set of potential head ends; and potential head ends with channel lineups that do not match the shopping network purse show at 2:30 pm for channel 9 may be removed from the set of potential head ends). In an example, the set of content may be evaluated to identify a premium media channel subscribed to through the head end (e.g., a winter Olympics package, a premium cable channel, a sports package, etc.).

In an example, a channel lineup for the head end may be provided (e.g., the intermediate multimedia device, such as the videogame console, may provide the channel lineup through the television display, such as through a videogame console operating system interface). Because the head end may be used to identify which media channels are subscribed to by the user, non-subscribed media channels may be excluded from the channel lineup. In an example, a set of user signals (e.g., a media channel viewing history user signal, an age user signal, a user profile user signal, a videogame console login profile user signal, an occupation user signal, a location user signal, and/or other descriptive user information) may be evaluated to identify a viewing preference of the user of the media receiver (e.g., where a user authorizes access to and/or use of/evaluation of such signals (e.g., by providing opt in consent)). A media channel suggestion may be provided based upon the viewing preference (e.g., a racing videogame review show at 4:00 pm may be suggested based upon the user having an interest in racing videogames through a videogame console profile and/or based upon the user posting racing videogame posts to a social network). Various functionality may be provided (e.g., an ability to record and share shows, an ability to block certain channels, direct access to on demand channels to which the user is subscribed, create social network posts about television shows, share snapshots of television shows through a social network, view user comments and/or reviews about television shows, etc.). At 114, the method ends.

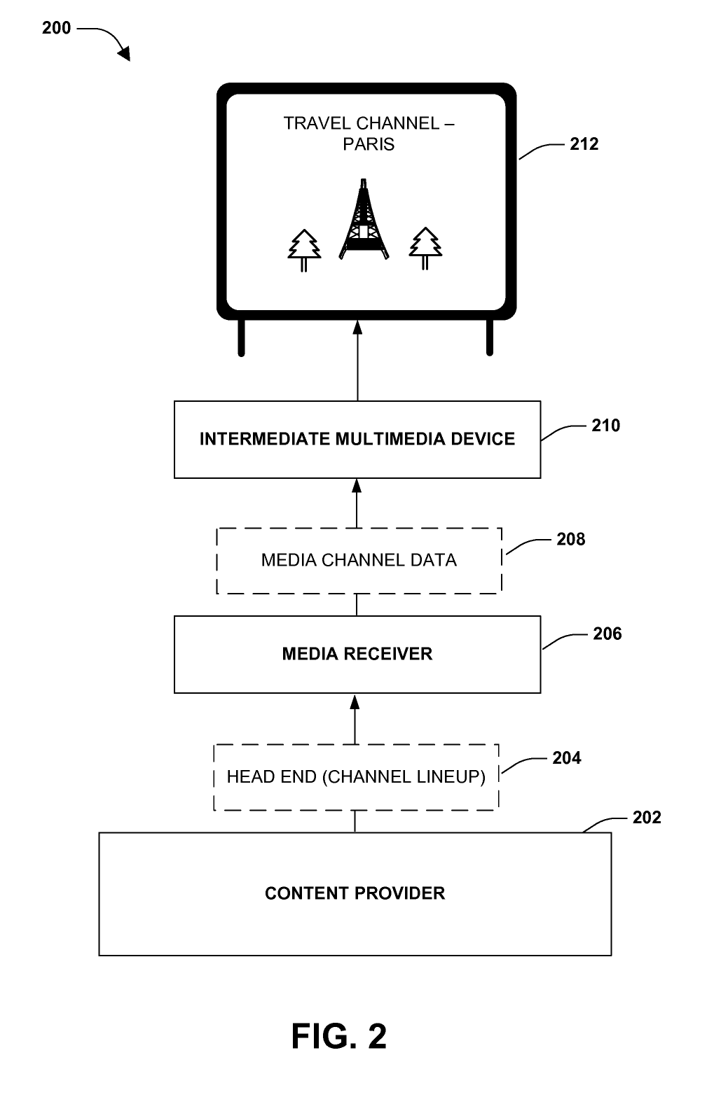

FIG. 2 illustrates an example 200 of providing cable television programming to a display 212. A content provider 202 (e.g., a cable television provider) may provide a head end 204 to a media receiver 206 (e.g., a cable box). The head end 204 may provide a channel lineup comprising one or more media channels of cable television programming to which a user may be subscribed. An intermediate multimedia device 210, such as a videogame console, a computing device, a mobile device, or any other device, may be communicatively coupled to the media receiver 206 by a first connection (e.g., a first HDMI or other connection). The intermediate multimedia device 210 may be communicatively coupled to a display 212, such as a television display, by a second connection (e.g., a second HDMI or other connection). In an example, the intermediate multimedia device 210 my receive media channel data 208, such as through a media channel signal received over the first connection, from the media receiver 206 (e.g., programming content for a Paris travel content show). The intermediate multimedia device 210 may display the Paris travel content show through the display 212 based upon the media channel data 208. Alternatively or additionally, the intermediate multimedia device 210 may obtain data (e.g., movies, shows, videogames, etc.) over a third connection, such as a connection to a cloud service (e.g., a videogame cloud service, a movie streaming cloud service, etc.) for presentation on the display 212. As provided herein, a head end detection component, configured to identify the head end 204, and/or an intermediate multimedia device component, configured to provide a robust cable television programming experience for the head end 204, may be associated with the intermediate multimedia device 210 and/or the display 212 (e.g., the head end detection component and/or the intermediate multimedia device component may be hosted on the intermediate multimedia device 210, the display 212, and/or on another computing device such as a remote visual content recognition service server).

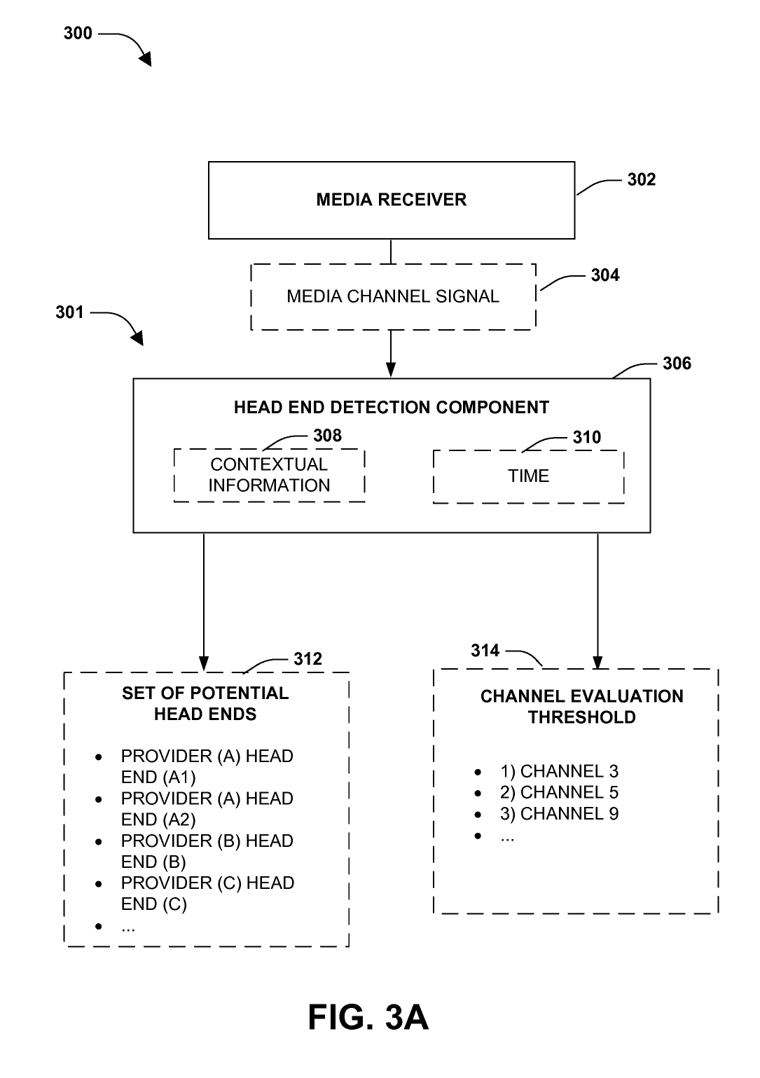

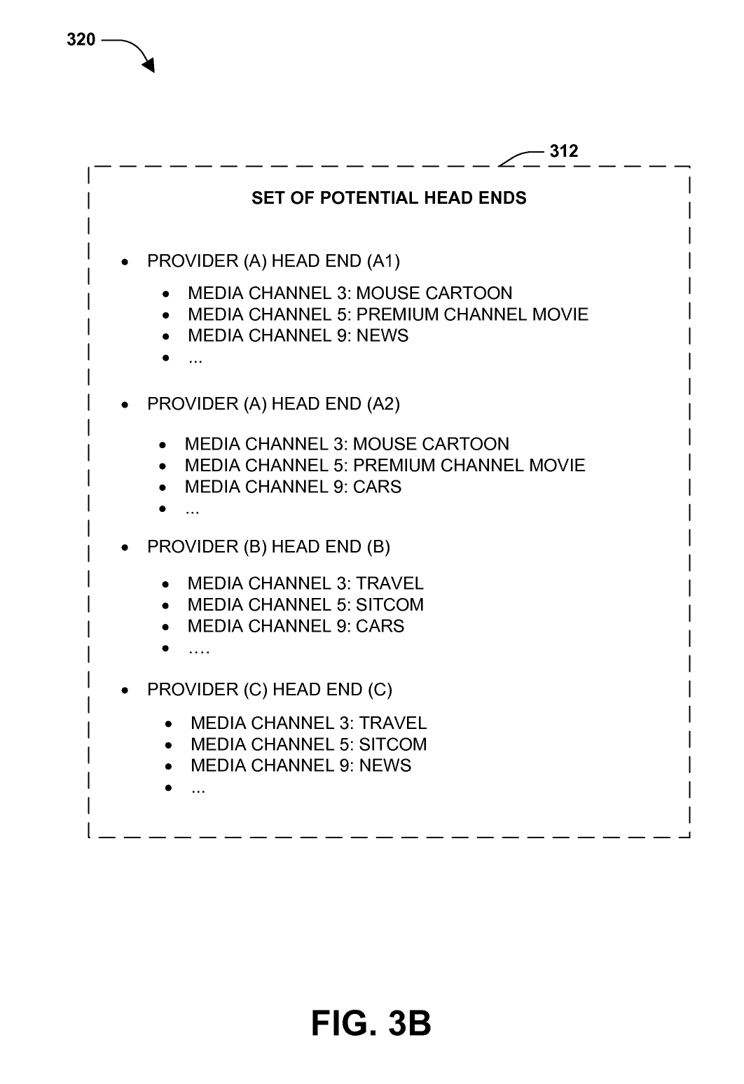

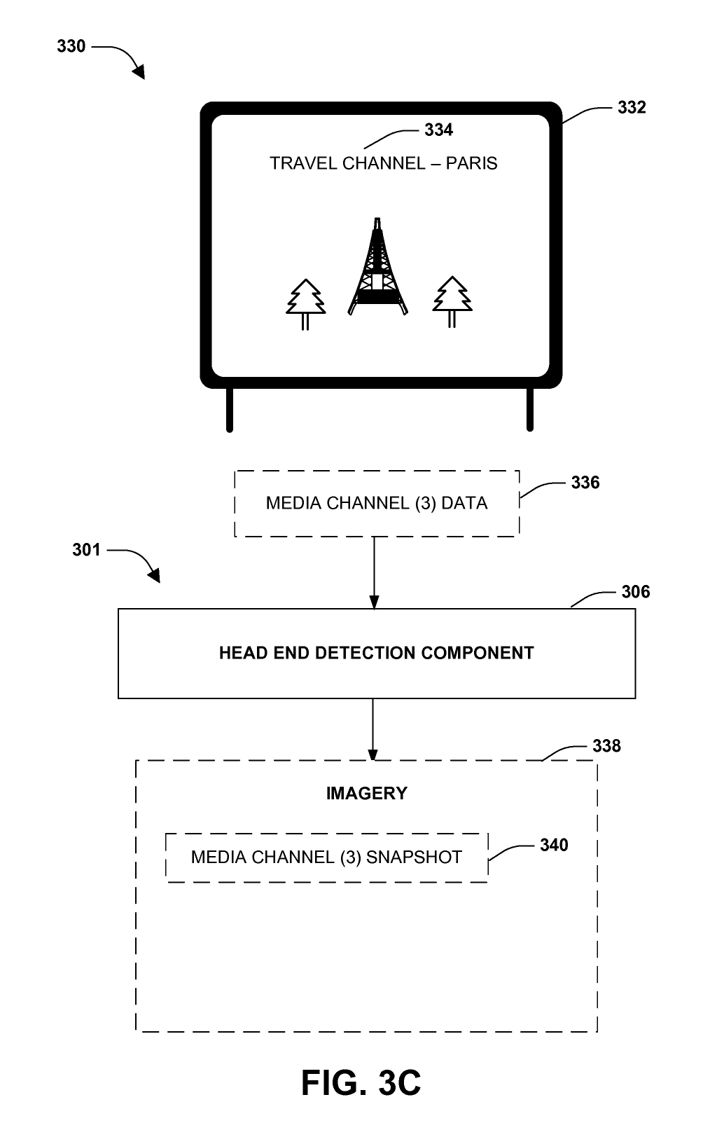

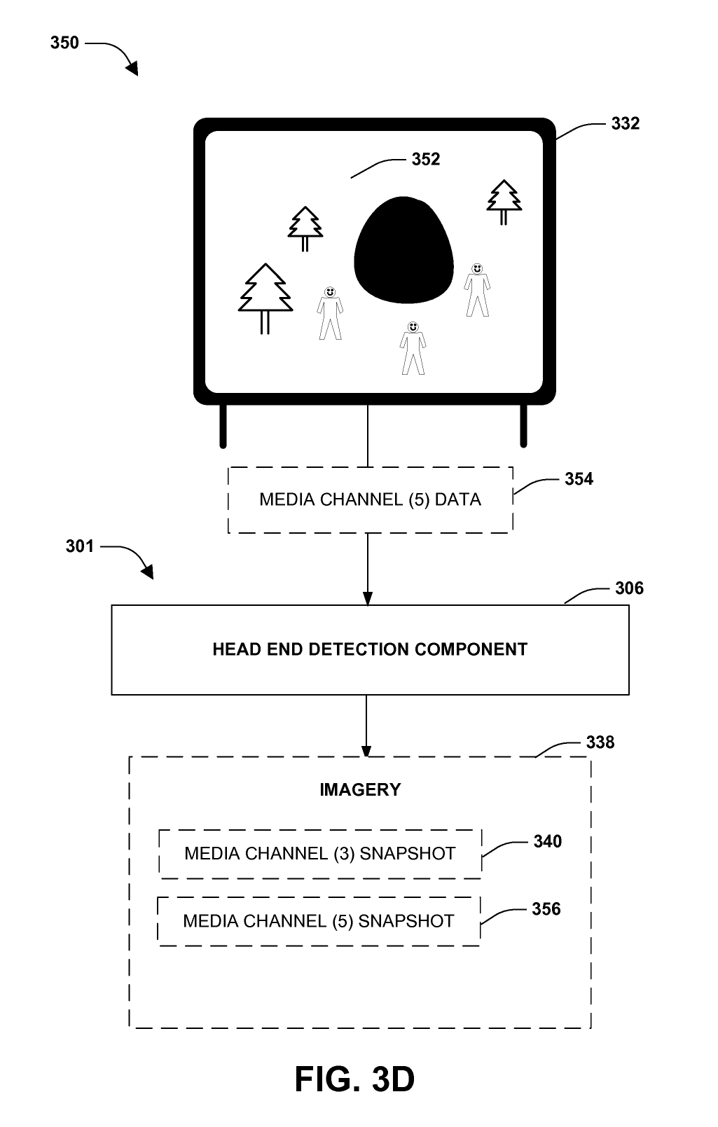

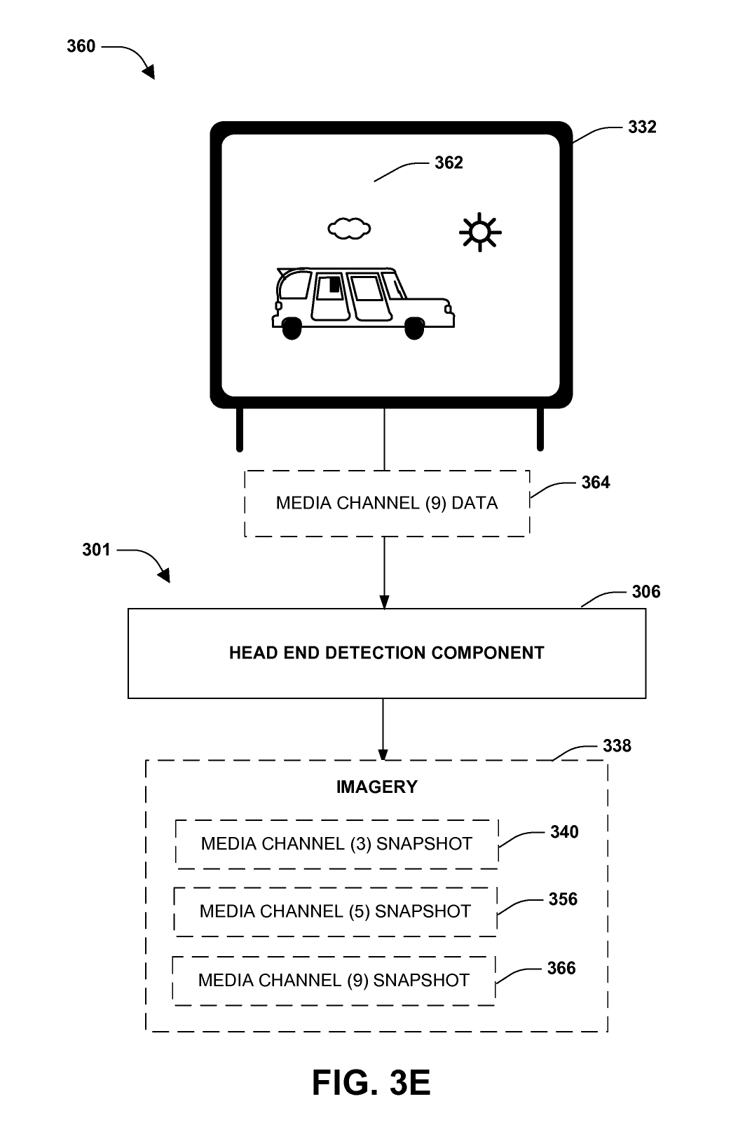

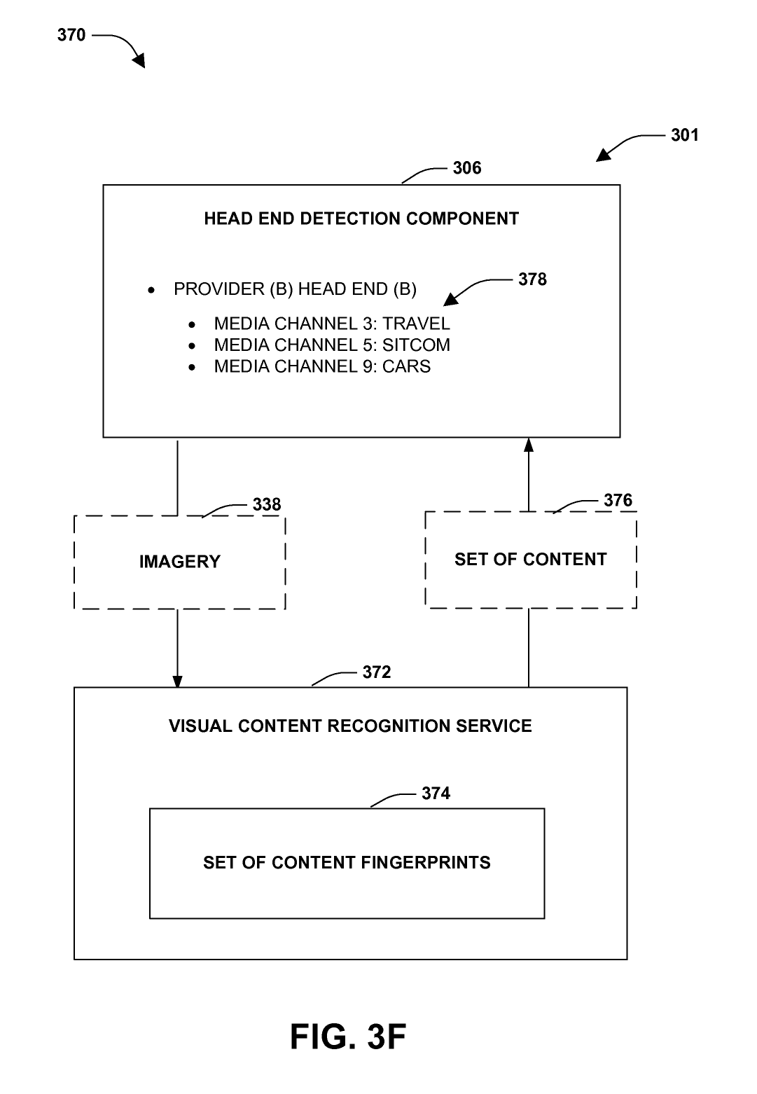

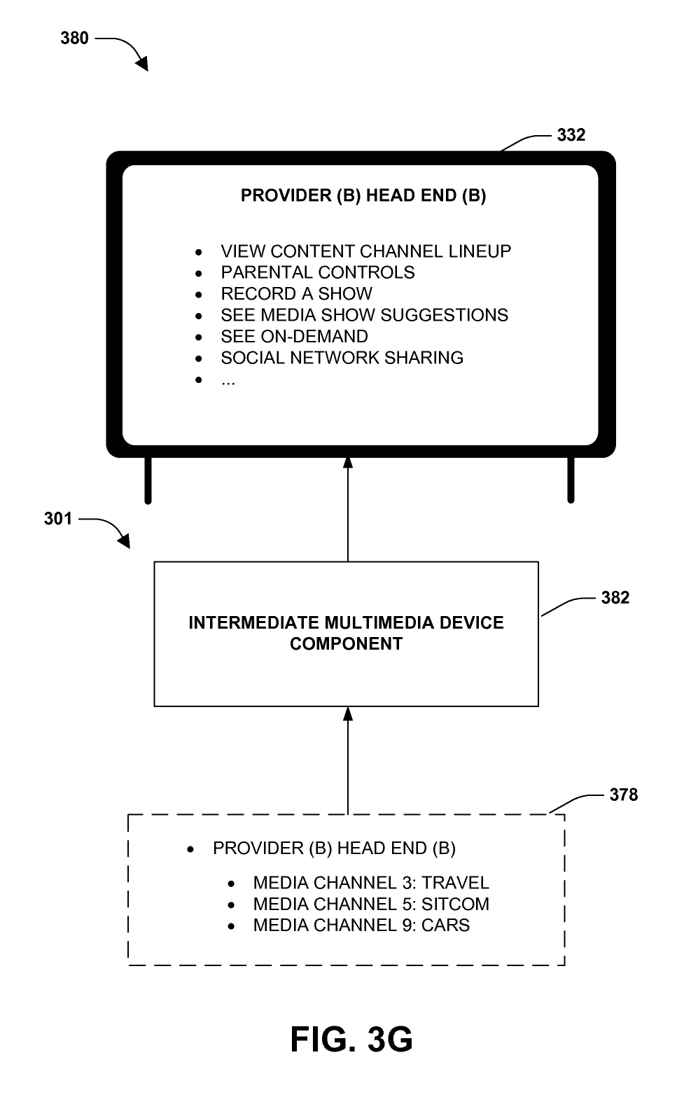

FIGS. 3A-3M illustrate examples of a system 301, comprising a head end detection component 306 and/or an intermediate multimedia device component 382, for head end detection. FIG. 3A illustrates an example 300 of identifying a set of potential head ends 312 and determining a channel evaluation threshold 314. The head end detection component 306 may be associated with a media receiver 302 (e.g., the head end detection component 306 may be hosted on a television or on an intermediate multimedia device such as a videogame console). The head end detection component 306 may be communicatively coupled to the media receiver 302 by a first connection. A media channel signal 304, comprising cable television programming for one or more media channels provided by a head end subscribed to by the media receiver 302, may be accessible to the head end detection component 306 over the first connection.

The head end detection component 306 may be configured to identify contextual information 308 (e.g., a location, a cable provider name, etc.) of the media receiver 302 and/or a current time 310. For example, the head end detection component 306 may evaluate an IP address of the intermediate multimedia device (e.g., the videogame console hosting the head end detection component 306) to identify a zip code, for example, as the contextual information 308. The head end detection component 306 may identify the set of potential head ends 312 based upon the contextual information 308 (e.g., available head ends for the zip code). For example, the set of potential head ends 312 may comprise content provider (A) head end (A1), a content provider (A) head end (A2), a content provider (B) head end (B), a content provider (C) head end (C), and/or other head ends available for the zip code. The head end detection component 306 may be configured to determine the channel evaluation threshold 314 based upon the contextual information 308, the time 310, and/or head end distinguishing channel information (e.g., distinguishing channels, within channel lineups of the potential head ends, that may be used to identify a single head end from the set of potential head ends 312 as being associated with the media receiver 302). In an example, the channel evaluation threshold 314 may indicate that 3 media channels, such as a media channel 3, a media channel 5, and a media channel 9, may be evaluated to identify the head end subscribed to by the media receiver 302 (e.g., content, such as television shows, on media channel 3, media channel 5, and media channel 9 may match a single potential head end within the set of potential head ends 312).

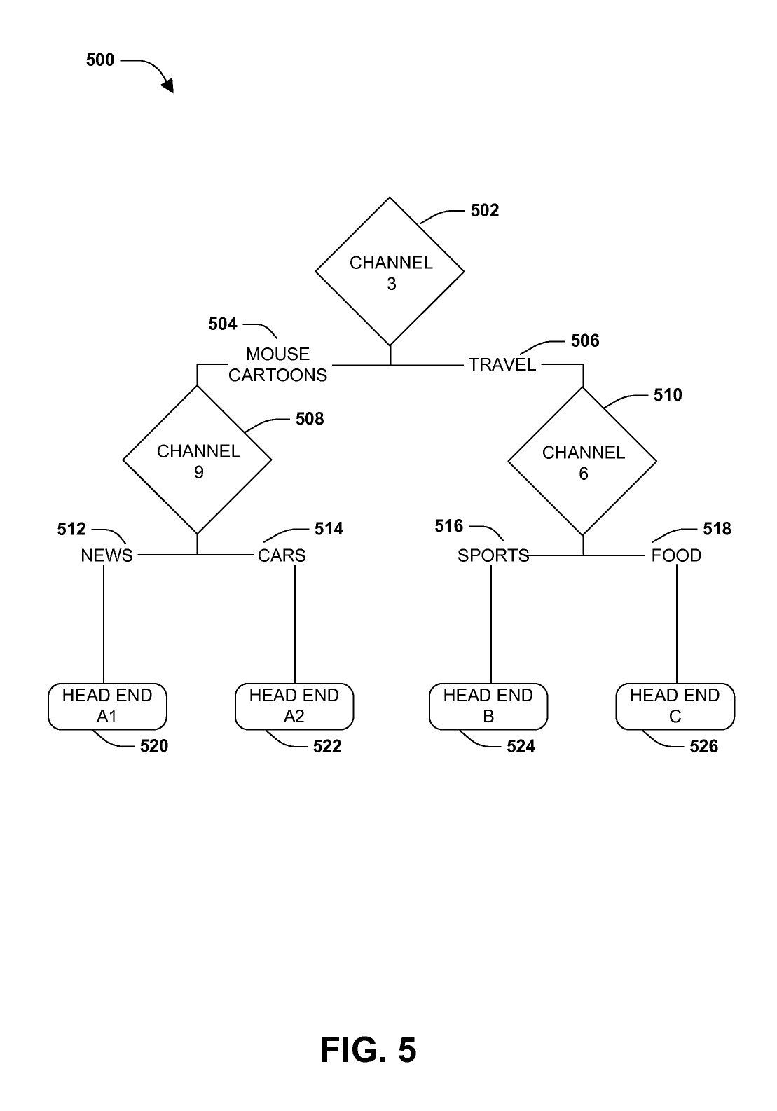

FIG. 3B illustrates an example 320 of the set of potential head ends 312 and/or the head end distinguishing channel information. For example, a first channel lineup of the content provider (A) head end (A1) may indicate that a mouse cartoon is on media channel 3, a premium channel movie is on media channel 5, and a news show is on media channel 9 at the time 310. A second channel lineup of the content provider (A) head end (A2) may indicate that the mouse cartoon is on media channel 3, the premium channel movie is on media channel 5, and a car show is on media channel 9 at the time 310. A third channel lineup of the content provider (B) head end (B) may indicate that a travel show is on media channel 3, a sitcom is on media channel 5, and the car show is on media channel 9 at the time 310. A fourth channel lineup of the content provider (C) head end (C) may indicate that the travel show is on media channel 3, the sitcom is on media channel 5, and the news show is on media channel 9 at the time 310. By evaluating media channel 3, media channel 5, and media channel 9, the set of potential head ends 312 may be filtered, by iteratively removing potential head ends that do not match content of such channels, to determine the head end associated with the media receiver 302 (e.g., if the media channel 3 is recognized as comprising travel show content, then the content provider (A) head end (A1) and the content provider (A) head end (A2) may be eliminated; if the media channel 9 is recognized as comprising car show content, then the provider (C) head end (C) may be eliminated; and thus the provider (B) head end (B) may be determined as the head end associated with the media receiver 302). In an example, the evaluation of channels may be implemented using a decision tree, as illustrated and described with reference to FIG. 5).

FIG. 3C illustrates an example 330 of the head end detection component 306 capturing imagery 338 from the media receiver 302. For example, the head end detection component 306 may capture a media channel (3) snapshot 340, for inclusion within the imagery 338, based upon media channel (3) data 336 associated with the media channel 3 specified within the channel evaluation threshold 314. For example, the media channel (3) snapshot 340 may illustrate a travel show 334 displayed through a television display 332.

FIG. 3D illustrates an example 350 of the head end detection component 306 capturing imagery 338 from the media receiver 302. For example, the head end detection component 306 may capture a media channel (5) snapshot 356, for inclusion within the imagery 338, based upon media channel (5) data 354 associated with the media channel 5 specified within the channel evaluation threshold 314. For example, the media channel (5) snapshot 356 may illustrate a sitcom 352 displayed through the television display 332.

FIG. 3E illustrates an example 360 of the head end detection component 306 capturing imagery 338 from the media receiver 302. For example, the head end detection component 306 may capture a media channel (9) snapshot 366, for inclusion within the imagery 338, based upon media channel (9) data 364 associated with the media channel 9 specified within the channel evaluation threshold 314. For example, the media channel (9) snapshot 366 may illustrate a car show 362 displayed through the television display 332.

FIG. 3F illustrates an example 370 of invoking a visual content recognition service 372 to identify a set of content 376 corresponding to the imagery 338. The head end detection component 306 may provide the imagery 338, comprising the media channel (3) snapshot 340, the media channel (5) snapshot 356, and the media channel (9) snapshot 364, to the visual content recognition service 372 (e.g., an automatic content recognition service). The visual content recognition service 372 may maintain a set of content fingerprints 374 corresponding to fingerprints of content. For example, a first content fingerprint may comprise features (e.g., identification of an actor, a network symbol, etc.) identified from content being broadcast from various head ends to the visual content recognition service 372. The visual content recognition service 372 may evaluate the imagery 338 against the set of content fingerprints 374 to identify the set of content 376 corresponding to the imagery 338. For example, the visual content recognition service 372 may determine that the media channel (3) snapshot 340 corresponds to a travel show content fingerprint associated with the travel show 334, the media channel (5) snapshot 356 corresponds to a sitcom content fingerprint associated with the sitcom 352, and the media channel (9) snapshot 366 corresponds the car show 362. In this way, the visual content recognition service 372 may provide the set of content 376, corresponding to the imagery 338, to the head end detection component 306.

The head end detection component 306 may iteratively remove potential head ends from the set of potential head ends 312, as illustrated in FIG. 3B, based upon the set of content 376 and/or head end distinguishing channel information to determine the head end associated with the media receiver 302. In an example where media channel 3 is evaluated, the head end detection component 306 may remove the provider (A) head end (A1) and the provider (A) head end (A2) from the set of potential head ends 312 because the first channel lineup for the provider (A) head end (A1) and the second channel lineup for the provider (A) head end (A2) indicate that the provider (A) head end (A1) and the provider (A) head end (A2) provide the mouse cartoon show during time 310 on media channel 3 instead of the travel show 334 identified within the set of content 376. In an example where media channel 5 is evaluated, the head end detection component 306 may remove the provider (A) head end (A1) and the provider (A) head end (A2) from the set of potential head ends 312 because the first channel lineup for the provider (A) head end (A1) and the second channel lineup for the provider (A) head end (A2) indicate that the provider (A) head end (A1) and the provider (A) head end (A2) provide the premium channel movie during time 310 on media channel 5 instead of the sitcom 352 identified within the set of content 376. The head end detection component 306 may remove the provider (C) head end (C) from the set of potential head ends because the fourth channel lineup for the provider (C) head end (C) indicates that the provider (C) head end (C) provides the news show on media channel (9) instead of the car show 362 identified within the set of content 376. It will be appreciated that evaluation and/or removal of head ends may be performed concurrently or serially. For example, removal of the provider (A) head end (A1) and the provider (A) head end (A2) from the set of potential head ends 312 may be performed based upon an evaluation of media channel 3 and/or media channel 5. Thus, an evaluation of media channel 5 may not be needed if media channel 3 is evaluated prior to media channel 5, for example. In this way, the set of potential head ends 312 is evaluated against the set of content 376 until the set of potential head ends 312 is indicative of the head end associated with the media receiver 302. For example, the set of potential head ends 312 may merely comprise the provider (B) head end (B) based upon the third channel lineup matching the travel show 334, the sitcom 352, and the car show 362 within the set of content 376. The provider (B) head end (B) may be identified as the head end 378 associated with the media receiver 302. In an example, the user may be asked to confirm the head end 378. In an example, where more than one potential head end are remaining within the set of potential head ends 312, the user may be asked to select a potential head end as the head end 378.

FIG. 3M illustrates an example 380 of the intermediate multimedia device component 382 (e.g., hosted on an intermediate multimedia device 210 such as a videogame console) providing functionality for the head end 378 associated with the media receiver 302. In an example, the intermediate multimedia device component 382 provides a channel lineup for the head end 378. One or more non-subscribed channels may be excluded from the channel lineup. In an example, intermediate multimedia device component 382 provides parental control access for the channel lineup (e.g., a user may specify viewing passwords for various channels). In an example, the intermediate multimedia device component 382 provides show recording functionality for the channel lineup. In an example, the intermediate multimedia device component 382 provides media show suggestions based upon a viewing preference of a user of the media receiver 302 (e.g., user signals, such as social network posts, a profile associated with the videogame console, a browsing history, videogame collection information, and/or a variety of other information may be evaluated (e.g., given user consent) to identify the viewing preference). In an example, the intermediate multimedia device component 382 provides access to on-demand channels that are subscribed to through the head end 378 (e.g., on-demand access to a premium movie channel). In an example, the intermediate multimedia device component 382 provides social network access where the user may share various information regarding the channel lineup (e.g., create a social network post that the user is watching the car show 262 on channel 9; post an image of the media channel (9) snapshot 366 illustrating the car show 362; add movie and television interests to a social network profile based upon shows watched by the user; etc.).

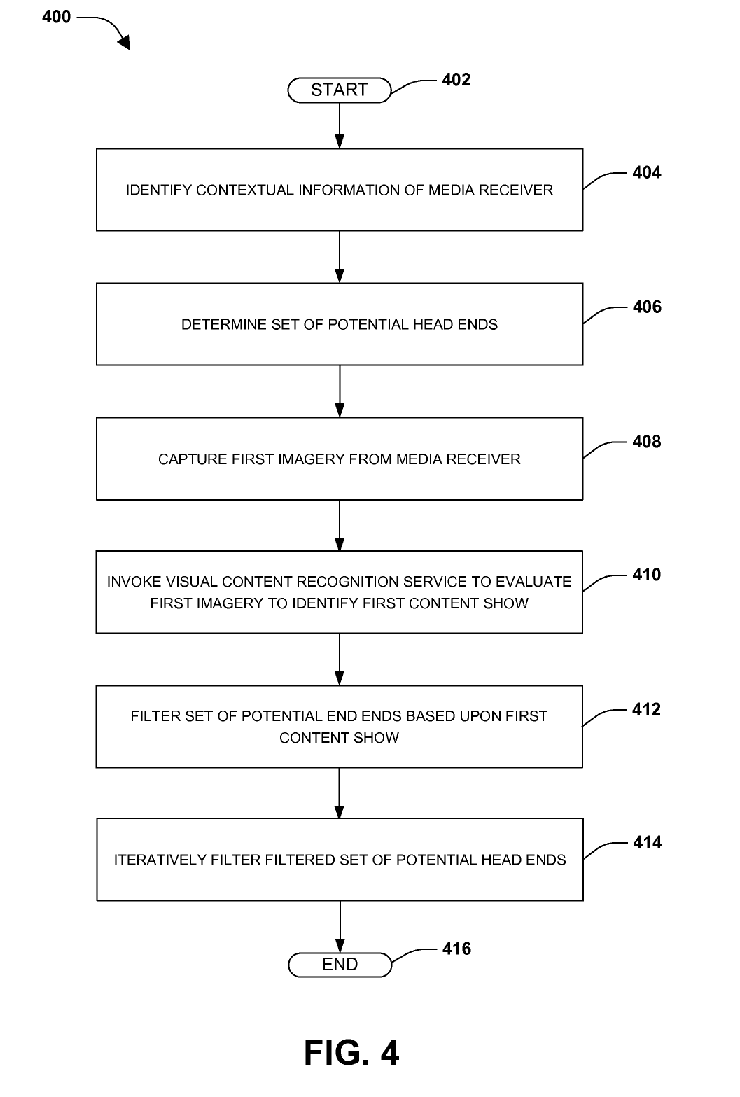

An embodiment of head end detection is illustrated by an exemplary method 400 of FIG. 4. At 402, the method starts. At 404, contextual information (e.g., a location, a cable provider name, etc.) of a media receiver may be identified. At 406, a set of potential head ends may be determined based upon the contextual information (e.g., a set of 10 potential head ends that may provide channel lineups to a particular zip code). At 408, first imagery may be captured from the media receiver. The first imagery may correspond to a first media channel (e.g., snapshot of media channel 3 at 2:00 pm). At 410, a visual content recognition service may be invoked to evaluate the first imagery against a set of content fingerprints (e.g., visual features of content shows, such as actors and network symbols, provided by various head ends) to identify a first content show of the first media channel (e.g., a race car show may be identified based upon the first imagery matching visual features of a race car show fingerprint of the race car show).

At 412, the set of potential head ends may be filtered based upon the first content show to create a filtered set of potential head ends (e.g., 3 potential head ends may be removed from the set of potential head ends, such that the filtered set of potential head ends comprises 7 potential head ends, because the 3 potential head ends do not have channel lineups that include the race car show at 2:00 pm). At 414, the filtered set of potential head ends are iteratively filtered, based upon content shows identified by invocation of the visual content recognition service using imagery captured form the media receiver, until the filtered set of potential head ends is indicative of a head end associated with the media receiver (e.g., until a single potential head end remains within the filtered set of potential head ends). For example, 5 more potential head ends may be filtered from the filtered set of potential head ends, such that the filtered set of potential head ends comprises 2 remaining head ends, because the 5 potential head ends do not include a football game show at 2:01 pm that was identified from second imagery captured from the media receiver on a second media channel. Third imagery from a third media channel may be captured from the media receiver, and may be identified as corresponding to a shopping show. A remaining potential head end may be filtered from the filtered set of potential head ends, such that the filtered set of potential head ends comprises a single potential head end, because the filtered remaining potential head end has a channel lineup that does not include the shopping show. In this way, the single potential head end, remaining within the filtered set of potential head ends, may be identified as being associated with the media receiver. At 416, the method ends.

FIG. 5 illustrates an example 500 of head end detection implemented using a decision tree (e.g., implemented by the head end detection component 306 of FIG. 3A). The decision tree may be populated with nodes that may be traversed along an efficient route (e.g., a shortest/faster route corresponding to an evaluation order with which to evaluation media channels) to identify a head end of a media receiver. For example, a first decision node 502 may evaluate channel 3 as part of the efficient route (e.g., channel 3 may be the most efficient channel to evaluate in order to identify the head end).

If channel 3 is playing mouse cartoons 504, then a second decision node 508 may indicate that channel 9 is the next efficient evaluation (e.g., channel 9 may be the next most efficient channel to evaluate in order to identify the head end when channel 3 is playing mouse cartoons 504). If channel 9 is playing news 512, then a head end (A1) 520 is identified as the head end. If channel 9 is playing car show content 514, then a head end (A2) 522 is identified as the head end.

If channel 3 is playing travel content 506, then a third decision node 510 may indicate that channel 6 is the next efficient evaluation (e.g., channel 6 may be the next most efficient channel to evaluate in order to identify the head end when channel 3 is playing travel content 506). If channel 6 is playing sports 516, then a head end (B) 524 is identified as the head end. If channel 6 is playing food content 518, then a head end (C) 526 is identified as the head end.

According to an aspect of the instant disclosure, a system for head end detection is provided. The system comprises a head end detection component. The head end detection component is configured to identify contextual information of a media receiver. The head end detection component is configured to determine a channel evaluation threshold based upon the contextual information and head end distinguishing channel information. The channel evaluation threshold is indicative of at least one of a number of media channels to evaluate or an evaluation order with which to evaluate media channels. The head end detection component is configured to capture imagery from the media receiver based upon the channel evaluation threshold. The head end detection component is configured to invoke a visual content recognition service to evaluate the imagery against a set of content fingerprints to identify a set of content corresponding to the imagery. The head end detection component is configured to evaluate the set of content against head end channel lineup information to determine a head end associated with the media receiver.

According to an aspect of the instant disclosure, a method for head end detection is provided. The method includes identifying contextual information of a media receiver. A channel evaluation threshold is determined based upon the contextual information and head end distinguishing channel information. The channel evaluation threshold is indicative of a number of media channels to evaluate. Imagery is captured from the media receiver based upon the channel evaluation threshold. A visual content recognition service is invoked to evaluate the imagery against a set of content fingerprints to identify a set of content corresponding to the imagery. The set of content is evaluated against head end channel lineup information to determine a head end associated with the media receiver.

According to an aspect of the instant disclosure, a method for head end detection is provided. The method includes identifying contextual information of a media receiver. A set of potential head ends is determined based upon the contextual information. First imagery is captured from the media receiver. The first imagery corresponds to a first media channel. A visual content recognition service is invoked to evaluate the first imagery against a set of content fingerprints to identify a first content show of the first media channel. The set of potential head ends are filtered based upon the first content show to create a filtered set of potential head ends. The filtered set of potential head ends are iteratively filtered, based upon content shows identified by invocation of the visual content recognition service using imagery captured form the media receiver, until the filtered set of potential head ends is indicative of a head end associated with the media receiver.

According to an aspect of the instant disclosure, a means for head end detection is provided. Contextual information of a media receiver is identified by the means for head end detection. A channel evaluation threshold is determined, by the means for head end detection, based upon the contextual information and head end distinguishing channel information. The channel evaluation threshold is indicative of at least one of a number of media channels to evaluate or an evaluation order with which to evaluate media channels. Imagery is captured, by the means for head end detection, from the media receiver based upon the channel evaluation threshold. A visual content recognition service is invoked, by the means for head end detection, to evaluate the imagery against a set of content fingerprints to identify a set of content corresponding to the imagery. The set of content is evaluated, by the means for head end detection, against head end channel lineup information to determine a head end associated with the media receiver.

According to an aspect of the instant disclosure, a means for head end detection is provided. Contextual information of a media receiver is identified by the means for head end detection. A set of potential head ends is determined, by the means for head end detection, based upon the contextual information. First imagery is captured, by the means for head end detection, from the media receiver. The first imagery corresponds to a first media channel. A visual content recognition service is invoked, by the means for head end detection, to evaluate the first imagery against a set of content fingerprints to identify a first content show of the first media channel. The set of potential head ends are filtered, by the means for head end detection, based upon the first content show to create a filtered set of potential head ends. The filtered set of potential head ends are iteratively filtered, by the means for head end detection, based upon content shows identified by invocation of the visual content recognition service using imagery captured form the media receiver, until the filtered set of potential head ends is indicative of a head end associated with the media receiver.

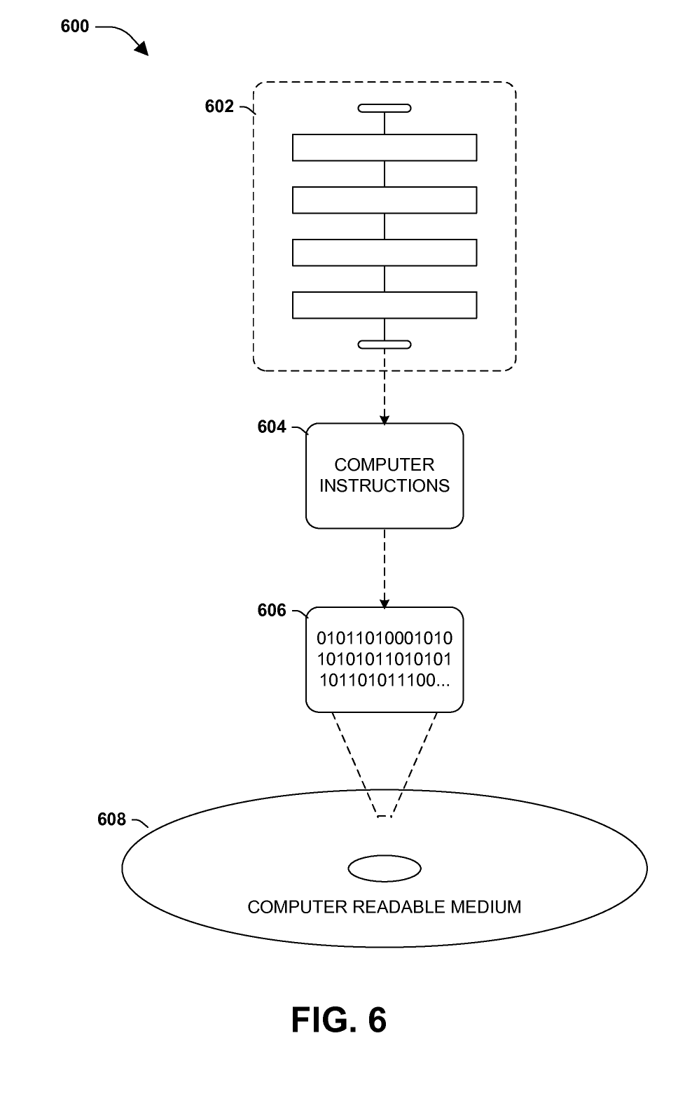

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1 and/or at least some of the exemplary method 400 of FIG. 4, for example. In some embodiments, the processor-executable instructions 604 are configured to implement a system, such as at least some of the exemplary system 301 of FIGS. 3A-3M, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

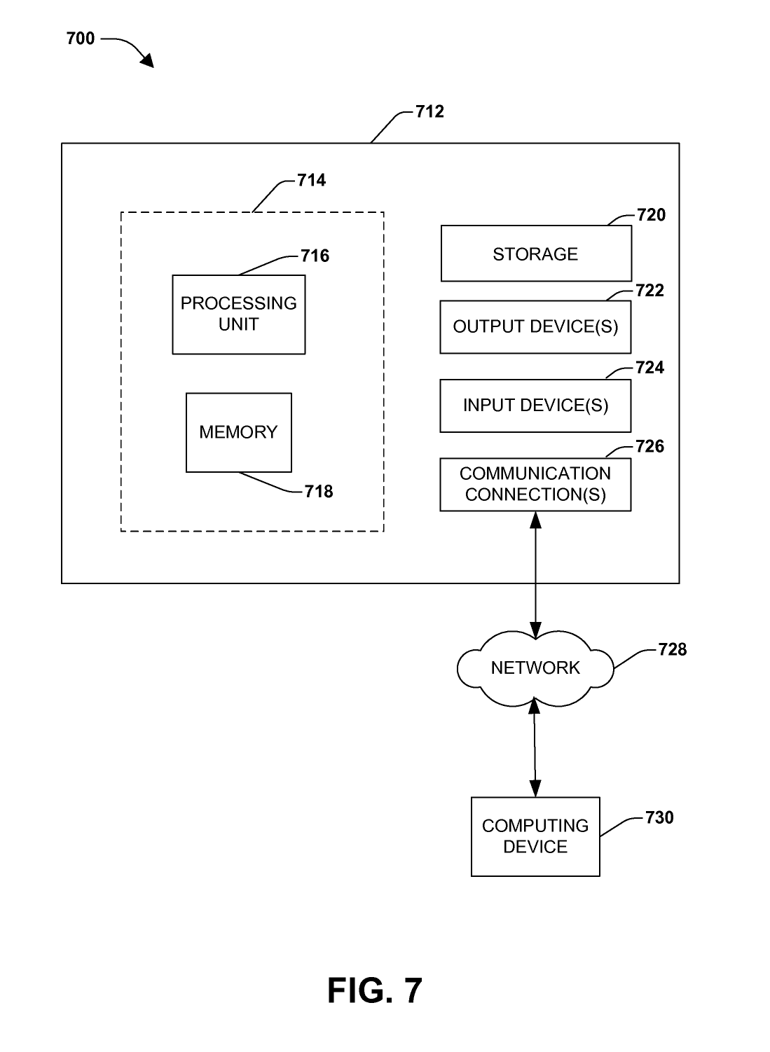

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Computer storage media does not, however, include propagated signals. Rather, computer storage media excludes propagated signals. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for head end detection, comprising:
a head end detection component configured to:
identify contextual information of a media receiver;
determine a channel evaluation threshold based upon the contextual information and head end distinguishing channel information, the channel evaluation threshold indicative of at least one of a number of media channels to evaluate or an evaluation order with which to evaluate media channels;
capture imagery from the media receiver based upon the channel evaluation threshold;
invoke a visual content recognition service to evaluate the imagery against a set of content fingerprints to identify a set of content corresponding to the imagery; and
evaluate the set of content against head end channel lineup information to determine a head end associated with the media receiver.

2. The system of claim 1, the head end detection component associated with an intermediate multimedia device communicatively coupled to the media receiver by a first connection and to a display by a second connection.

3. The system of claim 1, the channel evaluation threshold specifying a minimum set of media channels to evaluate.

4. The system of claim 1, the head end detection component configured to capture the imagery in real-time.

5. The system of claim 1, comprising:
an intermediate multimedia device component configured to:
provide a channel lineup for the head end; and
exclude one or more non-subscribed media channels from the channel lineup.

6. The system of claim 5, at least one of the head end detection component or the intermediate multimedia device component hosted on at least one of a videogame console or a television.

7. The system of claim 1, comprising:
an intermediate multimedia device component configured to:
evaluate a set of user signals to identify a viewing preference of a user of the media receiver; and
provide a media channel suggestion based upon the viewing preference.

8. The system of claim 7, the set of user signals comprising at least one of a media channel viewing history user signal, an age user signal, a user profile user signal, a videogame console login profile user signal, an occupation user signal, or a location user signal.

9. The system of claim 1, the head end detection component configured to:
evaluate at least one of an IP address, a wifi signal, a cellphone tower location, or a Bluetooth signal to identify the contextual information of the media receiver.

10. The system of claim 1, the head end detection component configured to:
identify a premium media channel subscribed to through the head end.

11. The system of claim 1, the head end detection component configured to:
tune to a media channel provided by the media receiver; and
capture a snapshot of the media channel for inclusion within the imagery.

12. The system of claim 1, the head end detection component configured to:
identify a set of potential head ends based upon the contextual information; and
iteratively remove potential head ends from the set of potential head ends based upon the set of content and the head end distinguishing channel information to determine the head end associated with the media receiver.

13. A method for head end detection, comprising:
identifying contextual information of a media receiver;
determining a channel evaluation threshold based upon the contextual information and head end distinguishing channel information, the channel evaluation threshold indicative of a number of media channels to evaluate;
capturing imagery from the media receiver based upon the channel evaluation threshold;
invoking a visual content recognition service to evaluate the imagery against a set of content fingerprints to identify a set of content corresponding to the imagery; and
evaluating the set of content against head end channel lineup information to determine a head end associated with the media receiver.

14. The method of claim 13, the capturing imagery comprising:
tuning to a media channel provided by the media receiver; and
capturing a snapshot of the media channel for inclusion within the imagery.

15. The method of claim 13, the evaluating comprising:
identifying a set of potential head ends based upon the contextual information; and
iteratively removing potential head ends from the set of potential head ends based upon the set of content and the head end distinguishing channel information to determine the head end associated with the media receiver.

16. The method of claim 13, comprising:
providing a channel lineup for the head end; and
excluding one or more non-subscribed media channels from the channel lineup.

17. The method of claim 13, comprising:
evaluating a set of user signals to identify a viewing preference of a user of the media receiver; and
providing a media channel suggestion based upon the viewing preference.

18. The method of claim 13, the channel evaluation threshold specifying a minimum set of media channels to evaluate.

19. The method of claim 13, capturing imagery comprising:
capturing a snapshot of a media channel for inclusion within the imagery in real-time during broadcast of the media channel.

20. A computer readable medium comprising instructions which when executed perform a method for head end detection, comprising:
identifying contextual information of a media receiver;
determining a set of potential head ends based upon the contextual information;
capturing first imagery from the media receiver, the first imagery corresponding to a first media channel;
invoking a visual content recognition service to evaluate the first imagery against a set of content fingerprints to identify a first content show of the first media channel;
filtering the set of potential head ends based upon the first content show to create a filtered set of potential head ends; and
iteratively filtering the filtered set of potential head ends, based upon content shows identified by invocation of the visual content recognition service using imagery captured from the media receiver, until the filtered set of potential head ends is indicative of a head end associated with the media receiver.
